(19) United States
(12) Patent Application Publication
(10) Pub. No.: US 2025/0282199 A1
(43) Pub. Date: Sep. 11, 2025

(54) Air Discharge System for a Vehicle

(71) Applicant: Illinois Tool Works Inc., Glenview, IL (US)

(72) Inventor: Günther Krämer, Enkenbach-Alsenborn (DE)

(21) Appl. No.: 19/069,997

(22) Filed: Mar. 4, 2025

(30) Foreign Application Priority Data
Mar. 11, 2024 (DE) 10 2024 106 861.2

(51) Int. Cl. B60H 1/00; B60H 1/34; B60S 1/54

(52) U.S. Cl. CPC B60H 1/00871; B60H 1/00485; B60H 1/00735; B60H 1/34; B60S 1/54

(57) ABSTRACT

The disclosure relates to an air vent system for a motor vehicle. The air vent system includes at least one main channel for conducting a first portion of a total airflow flowing through the air vent system, at least one bypass system for conducting a second portion of the total airflow flowing through the air vent system, and an airflow controller. The airflow controller subdivides the total airflow passing through the air vent system in such that (i) a portion of the total airflow flowing through the air vent system is only conducted through the at least one bypass system when a volumetric flow rate of the air flowing through the at least one main channel reaches or exceeds a first predefined or definable value; and/or (ii) a volumetric flow rate of the air flowing through the at least one main channel does not exceed a second predefined or definable value.

### RELATED APPLICATION

The present application claims the benefit of German Patent Application No. 10 2024 106 861.2, filed Mar. 11, 2024, titled “Air Discharge System for a Vehicle,” the contents of which are hereby incorporated by reference.

### BACKGROUND

In ventilation apparatuses for vehicles, air vents or air vent nozzles are typically used, which enable the exiting airflow to be controlled in a targeted manner. Such air vents are used in order to supply fresh air, in particular, into a motor vehicle interior.

The airflow flows through an inlet opening at an air inlet region of the air vent into the air channel, which is delimited by the housing wall of the air vent, through said air channel, and ultimately through an outlet opening at the air outlet region of the air vent into the interior of a motor vehicle (for example, a car or truck). The airflow generally follows a main flow direction, which can run in particular at least substantially parallel to a longitudinal axis of the housing of the air vent.

In known air vents, the airflow is deflected from the main flow direction by one or more air-guiding elements, for example pivotable air-guiding blades. In addition to the air-guiding elements, the housing of the air vent that delimits the air duct can also serve to deflect the air from the main flow direction. For example, air vents are known whose housing walls run arcuately in the direction of one another at least at the air inlet region, wherein an airflow directed by an air-guiding element in the direction of the arcuate housing wall follows the arc shape and thus undergoes a corresponding deflection. Such air vents are known, for example, from DE 20 2015 102 026 U1 and DE 10 2017 111 011 A1.

In addition, reference is made to DE 20 2013 012 285 U1. In the air vent known from this prior art, two mutually opposite housing walls of the air vent housing are designed in an arcuate fashion. An air-guiding element having a first air-guiding surface and a second air-guiding surface opposite the first air-guiding surface arranged in the air vent housing, wherein a first air channel is formed by the housing and the first air-guiding surface, and a second air channel is formed by the housing and the second air-guiding surface. The first air channel is configured in order to transport a first volumetric flow of air that can be passed into the housing through the air inlet opening to the air vent opening, while the second air channel is configured in order to transport a second volumetric flow of air that can be passed into the housing through the air inlet opening to the air vent opening.

In addition, in the air vent known from DE 20 2013 012 285 U1, a wing element is arranged in the housing, wherein the wing element is movably arranged in an air inlet section between the air inlet opening and the end of the air-guiding element facing said opening. The movability of the wing element is configured such that the direction of the air exiting the air vent opening is adjusted due to the position of the wing element. However, due to the arcuate design of the housing wall, such air vents are quite complex to manufacture, in particular by way of a plastic injection molding method. Furthermore, the air vent known from DE 20 2013 012 285 U1 has certain disadvantages, in particular with respect to the overall achievable throughput of the amount of air to be introduced into the interior of the vehicle.

In particular, the functionality of the air vent known from DE 20 2013 012 285 U1 is based on the fact that the air deflection is achieved by varying the volumetric flows (first and second volumetric flow) through the two air ducts that are formed using the air guiding element. By adjusting or varying the ratio of the volumetric flows flowing through the first and second air ducts of the known air vent, a desired air deflection of the air flowing out of the air outlet region of the air vent is substantially performed.

However, it has been shown that such a mechanism for causing air deflection reduces the performance of the air vent, i.e., the volumetric flow that can be emitted by the air vent per unit of time and/or the “quality” of the airflow that can be emitted by the air vent, in particular with regard to airflow fanning and direction. Above all, with the approach known from DE 20 2013 012 285 U1, for example, an evenly distributed volumetric flow at the air outlet region of the air vent cannot be achieved for different positions of the air vent.

Apart from these disadvantages, the air vent known from DE 20 2013 012 285 U1, in particular, has conceptual disadvantages in terms of air deflection. For example, even in the straight alignment of the air-guiding elements, the known air vents often divert or deflect the air repeatedly within the housing of the air vent, which results in an increased flow resistance. The effect of the air-guiding elements accommodated in the housing of the air vent is thereby significantly impaired, in particular for horizontal air deflection. In addition, due to the increased flow resistance upstream of the outlet opening of the air vent, the exiting airflow is widened, which is also generally not desired.

A further disadvantage of known air vents is that the air-guiding elements arranged in the air channel, such as air-guiding blades, limit the flow region that is available for the air. This is true in particular in the region of the end positions of the air-guiding elements. Limitations of the available flow region of more than 50% can occur.

In addition, for design reasons, there is increasing desire to integrate the outlet openings of the air vents into the overall instrument panel design harmoniously as slit-shaped openings. There is thus a need for slit or line air vents with the most discrete vent openings as possible.

However, the problem with slit or line air vents can be seen in the fact that the reduced vent openings result in a high pressure drop. In particular, a relatively large amount of air (high flow rate) cannot be conducted into the interior of the vehicle with such slit or line air vents, or can be conducted only with a high amount of effort per time unit; however, this is desirable, for example, for warming up the interior in winter or for air conditioning the interior.

Even if the high pressure drop associated with slit or line air vents is accepted, noise is in particular unavoidable at high flow rates, which is also usually not acceptable. Thus, design freedom is limited when integrating air vents into the interior of a vehicle. The air vents or air nozzles must have a certain opening size and a certain flow region so that a relatively high flow rate can be directed into the interior of the vehicle via the air vents if needed, without the noise increasing too much and while keeping the pressure drop within an acceptable frame.

Based on this problem, the object of the disclosure is thus to further develop an air vent system of the aforementioned type in such that, despite the provision of slit-shaped outlet openings, the overall performance of the air vent system is not negatively affected, while simultaneously providing a relatively simple construction.

### SUMMARY

The present disclosure relates generally to an air vent system, substantially as illustrated by and described in connection with at least one of the figures, as set forth more completely in the claims. In one example, the present disclosure relates to air vent systems for motor vehicles. Such air vent systems are in particular part of or form part of a ventilation system of a vehicle.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a sectional view, a first exemplary embodiment of the air vent according to the disclosure.

FIG. 2 illustrates schematically and in a sectional view, a second exemplary embodiment of the air vent according to the disclosure.

FIG. 3 illustrates schematically and in a sectional view, a third exemplary embodiment of the air vent according to the disclosure.

FIG. 4 illustrates schematically and in a sectional view, a fourth exemplary embodiment of the air vent according to the disclosure.

FIG. 5 illustrates schematically and in a sectional view, a fifth exemplary embodiment of the air vent according to the disclosure.

FIG. 6 illustrates schematically and in a sectional view, a sixth exemplary embodiment of the air vent according to the disclosure.

FIG. 7 illustrates schematically and in a sectional view, a seventh exemplary embodiment of the air vent according to the disclosure.

FIG. 8 illustrates schematically and in a sectional view, an eighth exemplary embodiment of the air vent according to the disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The air vent systems considered herein are in particular characterized by the fact that they comprise a combination of various air vents, such as air vents installed in the dash of the vehicle, air vents directed at the vehicle windshield, or air vents directed into the footwell of the vehicle.

An object of the disclosure is thus to further develop an air vent system of the aforementioned type in such that, despite the provision of slit-shaped outlet openings, the overall performance of the air vent system is not negatively affected, while simultaneously providing a relatively simple construction.

In particular, the object of the disclosure is to provide an air vent system that optimizes the performance of the air vent system despite a slit or line-shaped vent opening of air vents of the air vent system and at the same time allows for as much design freedom as possible.

This problem is solved according to the disclosure by an air vent system for a motor vehicle according to the independent claim 1, wherein advantageous further developments of the air vent system according to the disclosure are specified in the dependent claims.

Accordingly, the disclosure in particular relates to an air vent system for a motor vehicle, whereby the air vent system comprises at least one main channel for conducting a first portion of a total airflow flowing through the air vent system and at least one bypass system for conducting a second portion of the total airflow flowing through the air vent system. In addition, an airflow controller is used which is configured to subdivide the total airflow flowing through the air vent system.

Specifically, the airflow controller of the air vent system is configured to subdivide the total air flow passing through the air vent system in such that (i) a portion of the total airflow flowing through the air vent system is only conducted through the at least one bypass system of the air vent system when a volumetric flow rate of the air flowing through the at least one main channel reaches or exceeds a first predefined or definable value; and/or (ii) a volumetric flow rate of the air flowing through the at least one main channel does not exceed a second predefined or definable value.

By providing the bypass system with the corresponding airflow control, it is achieved in an easily realized but effective manner that only a pre-determined or determinable maximum airflow may flow through the main channel of the air vent system. The main channel of the air vent system is preferably connected in a fluidic manner to an air vent integrated in the dashboard of the vehicle, for example.

In particular, the air vent may be provided with a slit-shaped outlet opening, as the bypass system ensures that only an upwardly limited air flow rate is supplied to the air vent. The air vent, which is connected to the main channel via a fluidic connection, can thus be integrated harmoniously into the overall design, for example.

Because the volume flow rate of the air passing through the at least one main channel is not permitted to exceed a pre-determined or fixed (second) level by way of the airflow controller, it is ensured that very little—if any—noise is produced when the air passes through the main channel and is blown out into the interior of the vehicle via the at least one air vent connected to the main channel.

Nevertheless, the overall performance of the air vent system is not compromised. This applies in particular in situations in which a relatively high flow rate must be fed into the vehicle interior within a relatively short period of time via the air vent system, for example, for air conditioning or heating the vehicle interior. For such situations, it is imperative that the total airflow flowing through the air vent system is increased.

In this case, the airflow controller engages because, with the aid of the airflow controller, at least a portion of the total airflow passing through the air vent system is conducted through the bypass system (and no longer through the main channel). With this easily implemented but nevertheless effective measure, it is thus ensured that only a relatively small portion of the total airflow passes through a slit or line vent which is connected to the main channel of the air vent system via a fluidic connection, even if the volume flow rate of the total airflow flowing through the air vent system is to be increased. The other portion of the total airflow passing through the air vent system is directed into the interior of the vehicle via the bypass system. Thus, the total pressure drop of the air vent system is at least partially decoupled from the total airflow passing through the air vent system over at least a certain range.

According to preferred realizations of the air vent system according to the disclosure, it is provided that the at least one main channel is divided into an upstream first region and a downstream second region. The bypass system is or can be connected through a fluidic connection via the airflow controller to a region of the at least one main channel, wherein this region of the at least one main channel lies between the upstream first region and the downstream second region of the at least one main channel.

At least one air vent is then connected through a fluidic connection to the downstream second region of the at least one main channel, wherein said at least one air vent is preferably an air vent arranged/integrated in the dashboard or in the area of the dashboard of the vehicle, in particular with a slit-shaped or linear outlet opening.

In a further development of the most recently mentioned design variant of the air vent system according to the disclosure, it is provided that at least one adjustable airflow regulating element is arranged in the downstream second region of the at least one main channel. This at least one adjustable airflow regulating element is in particular a flap, in particular a dosing flap. Alternatively, however, it is also conceivable that the adjustable airflow regulating element is configured in the form of a closing lamellar system.

Preferably, the airflow controller comprises at least one pressure sensor. The pressure sensor is configured so as to sense a pressure, in particular a static pressure, in particular in the downstream second region of the at least one main channel.

With this measure, it is ensured in an easy-to-implement, yet effective manner that a flow rate of the air flowing through the downstream second region of the at least one main channel does not exceed the pre-determined or fixed (second) value, because preferably the pressure sensor transmits the corresponding signal to the airflow controller when a proportion of the total airflow passing through the air vent system is to be diverted and passed through the bypass system.

In this context in particular, it is useful that the airflow controller comprises at least one motor-controllable valve unit, via which the bypass system is or can be fluidly connected to a region of the at least one main channel between the upstream first region and the downstream second region of the at least one main channel.

However, the present disclosure is not limited to air vent systems in which static pressure is sensed via at least one pressure sensor, particularly in the downstream second region of the at least one main channel, in order to conduct a portion of the total air flowing through the bypass system through the air vent system as needed to satisfy the aforementioned conditions (i) and (ii).

It is, for example, also conceivable that the airflow controller comprises a check assembly (check valve, etc.), which is arranged or configured such that, when a predefined or definable pressure, in particular a static pressure, is exceeded in the at least one main channel, the check assembly opens and conducts a portion of the total airflow flowing through the air vent system through the at least one bypass system, and in particular such that the aforementioned conditions (i) and (ii) are fulfilled.

According to implementations of the air vent system according to the disclosure, it is provided that the at least one main channel is embodied as a first air channel for supplying air to at least a first air vent. As already stated, this at least one first air vent is in particular an air vent that is directly visible in the vehicle interior. This is an air vent in the dash or on the dash of the vehicle, for example, wherein this air vent is harmoniously integrated into the overall instrument panel design, since slit or line outlets are in particular conceivable for the at least one first air vent.

The bypass system may comprise at least one bypass channel that is connected to a second air passage via a fluidic connection for supplying air to a second air vent. For example, the second air vent may be a defroster nozzle or at least one footwell nozzle.

According to further embodiments of the air vent system according to the disclosure, the air vent system further comprises a climate control unit, which is configured so as to supply an airflow to the at least one main channel and/or an airflow to at least one further air channel as needed.

It is useful in this case that the climate control unit is configured so as to adjust a volumetric flow rate of the airflow supplied to the at least one further air channel in the at least one main channel as a function of a pressure, in particular a static pressure. The climate control unit preferably comprises a corresponding pressure sensor.

In summary, the principle underlying the present disclosure includes the air passing through a vent opening of an air vent, as is customary. At higher blower positions, i.c., when the total airflow passing through the air vent system is increased, on the other hand, the total pressure in the vent opening of the at least one air vent increases. When the total pressure reaches a certain level, the airflow controller becomes active, for example, by actively or passively opening a valve so that at least a portion of the air can flow from the main channel into another channel of the bypass system, in order to ultimately enter the passenger compartment via the bypass system.

This mechanism ensures that the volumetric flow rate required for climate control in the vehicle interior can be conducted into the vehicle interior at least partially via an air vent opening of an air vent with a relatively small cross section, without the system having too much flow resistance to this.

In particular, a pressure sensor may be employed that emits a signal when a certain (static) pressure is reached in the system, and in particular in the downstream second region of the at least one air channel, as a result of which a flap is activated, for example in the climate control unit, such that the flap opens more or less widely so that the flow rate can exit at another location.

The air vent system according to the disclosure and the system underlying the disclosure allow for significantly greater design freedom, since ventilation nozzles or air vents can be realized, which can be significantly narrower and smaller in cross-section than previously known types of ventilation nozzles or air vents without losing the function of a significant airflow to the vehicle occupant. This means that fully functional ventilation nozzles or air vents can also be more easily integrated in smaller areas in the passenger compartment, for example in joints and design edges. This enables more discrete solutions in the sense of “clean IP.”

Also, by limiting the internal pressure of the vent through which air flows that is connected via a fluidic connection to the at least one main channel of the air vent system, the flow of the vent or air vent system may be limited, which positively affects the noise emissions produced by the ventilation system. In this system, the flow through the vent is limited by limiting the internal pressure without affecting the climate control unit (air conditioning system) of the vehicle, as the amount of air entering the vehicle via the bypass system and the amount of air vented into the vehicle remains the same.

By dissipating the positive pressure in the vent via the bypass system, the blower capacity can also be reduced as the pressure drop throughout the overall system is reduced. This means that equivalent vehicle climate control can be achieved with lower blower output.

This also leads to a reduction in energy consumption for climate control and, in the case of electric vehicles, to an improvement in range.

The exemplary embodiments of the air vent system 1 according to the present disclosure, as shown schematically in a sectional view in each of the accompanying drawings, each comprise a main channel 2, a bypass system 3, and an airflow controller 4.

The main channel 2 is used to conduct a (first) portion of a total airflow flowing through the air vent system 1. The bypass system 3 serves to conduct a (second) portion of the total airflow flowing through the air vent system 1 as needed. The airflow controller 4 is configured so as to subdivide the total airflow passing through the air vent system 1 accordingly.

Specifically, the airflow controller 4 is configured to subdivide the total airflow flowing through the air vent system 1 in such that, on the one hand, a portion of the total airflow passing through the air vent system 1 is only passed through the at least one bypass system 3, when a flow rate of the air flowing through the at least one main channel 2 reaches or exceeds a first predetermined or fixed value, and that, on the other hand, a volume flow rate of the air flowing through the at least one main channel 2 does not exceed a second predetermined or fixed value.

The air vent systems 1 shown in the drawings each have three different air vents 11, 12, 13.

On the one hand, a first air vent 11 is used, which is connected to the main channel 2 via a fluidic connection, and in particular to a downstream end region 6 of the main channel 2. The first air vent 11 may be an air vent disposed in an instrument panel 21 of the vehicle.

Alternatively, however, the first air vent 11 can also be an air vent integrated in an edge or marginal region in the vehicle interior.

The air vent system 1 further comprises at least one defroster nozzle as a second air vent 12, which is disposed in the area of the windshield 20 of the vehicle and configured to direct air onto the windshield 20 if necessary in order to, for example, de-ice it or to avoid water condensation.

At least one footwell nozzle is used in embodiments of the air vent system 1 shown in the drawings as a third air vent 13.

The above-mentioned air vents 11, 12, 13 (first air vent 11 in the form of the air vent arranged, for example in an instrument panel 21 of the vehicle, second air vent 12 in the form of at least one defroster nozzle, and third air vent 13 in the form of the at least one footwell nozzle) are each connected to a climate control unit 30 of the vehicle through a fluidic connection via an air channel 2, 14, 15. The climate control unit 30 preferably comprises a corresponding blower with which the total airflow flowing through the air vent system 1 is generated.

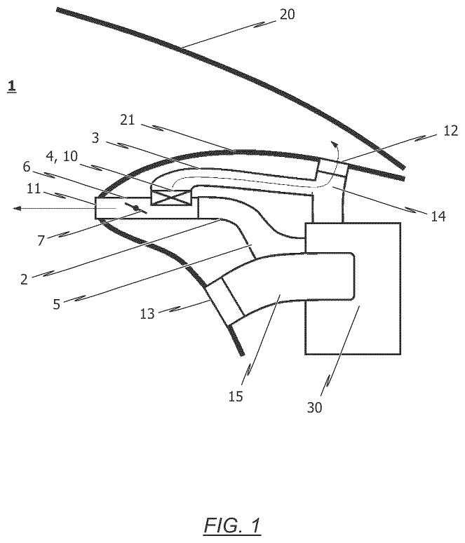

In the design variant of the air vent system 1 according to the disclosure shown in FIG. 1, the bypass system 3 is configured in the form of a bypass channel, which on the one hand opens into the air channel 14, which leads to the second air vent 12 (i.e., to the defroster nozzle). On the other hand, the bypass channel is connected or can be connected via a fluidic connection to the main channel 2 of the air vent system 1.

The bypass channel is connected to the main channel 2 of the air vent system 1 via a fluidic connection in the design variant of the air vent system 1 according to the disclosure shown in FIG. 1 via a check assembly 10, which is arranged or configured in such that, if a predetermined or fixed pressure is exceeded, in particular a static pressure, the check assembly 10 in the main channel 2 opens and directs a portion of the total airflow passing through the air vent system 1 through the bypass channel of the bypass system 3, such that this portion of the air flow is fed to the second air vent 12, i.e., the defroster nozzle.

In particular, it can be seen that the main channel 2 is divided into an upstream first region 5 and a downstream second region 6. The bypass channel of the bypass system 3 is connected or can be connected to a region of the main channel 2 between the upstream first region 5 and the downstream second region 6 of the main channel 2 via the airflow controller 4. The check assembly 10 is part of the airflow controller 4.

It can also be seen that at least one adjustable airflow regulating element 7 can be arranged in the downstream second region 6 of the main channel 2. The adjustable airflow regulating element 7 is, for example, a flap, in particular a dosing flap, although it is also conceivable that this airflow regulating element 7 is designed in the form of a closing lamellar system.

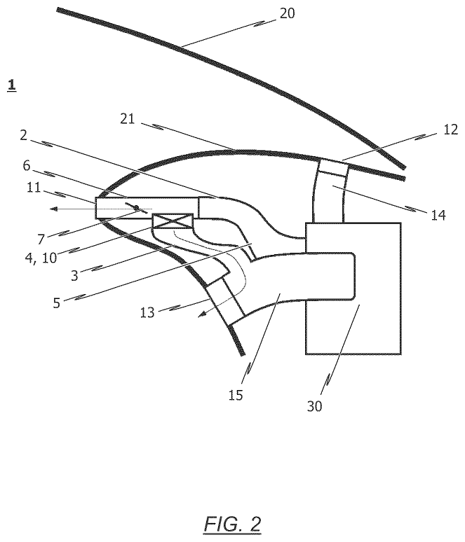

The second exemplary embodiment of the air vent system 1 according to the disclosure shown in FIG. 2 substantially corresponds to the first exemplary embodiment described above according to FIG. 1, wherein, however, in the design variant of the air vent system 1 according to the disclosure shown in FIG. 2, the bypass channel of the bypass system 3 does not open up into the air channel 14 for the second air vent 12, i.e., not into the air channel for the defroster nozzle, but rather into the air channel 15 for the third air vent 13, that is to say, into the air channel 15 for the footwell nozzle.

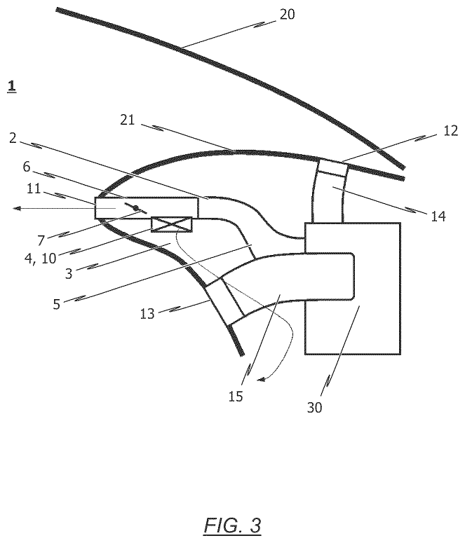

The design variant of the air vent system 1 according to the disclosure shown schematically in FIG. 3 differs from the design variants described above with reference to the illustrations in FIG. 1 and FIG. 2 in that the bypass system 3 is designed without a dedicated bypass channel. Instead, in the design variant shown schematically in FIG. 3, the volume range enclosed by the interior trim of the vehicle serves as a bypass in order to divert a portion of the airflow passing through the main channel 2 as needed and vent it into the interior enclosed by the vehicle trim.

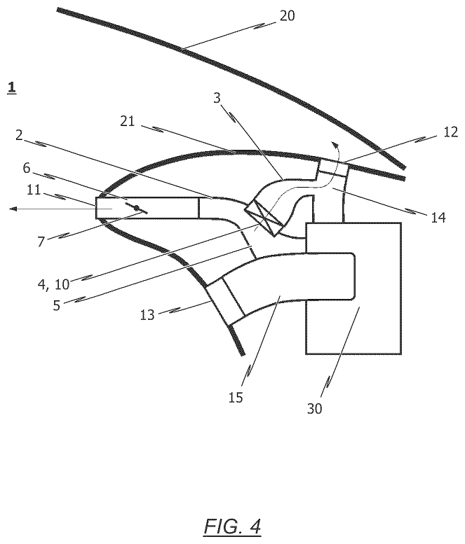

The fourth exemplary embodiment of the air vent system 1 according to the present disclosure shown in FIG. 4 substantially corresponds to the first exemplary embodiment shown in FIG. 1, although in the embodiment shown in FIG. 4, the subdivision of the main channel 2 into the first upstream region 5 and the second downstream region 6 is implemented differently. In detail, the upstream, first region 5 of the main channel 2 is provided in the immediate vicinity of the climate control unit 30.

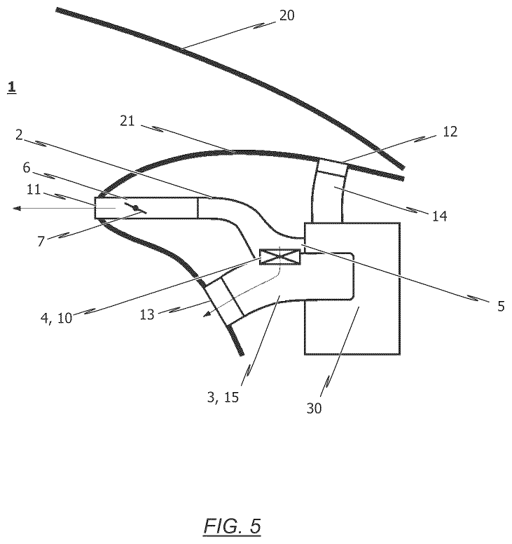

The same applies accordingly to the design variant of the air vent system 1 shown schematically in FIG. 5, which corresponds essentially to the second exemplary embodiment shown in FIG. 2, although here as well the subdivision of the main channel 2 into the first upstream region 5 and into the second downstream region 6 is shifted accordingly towards the climate control unit 30.

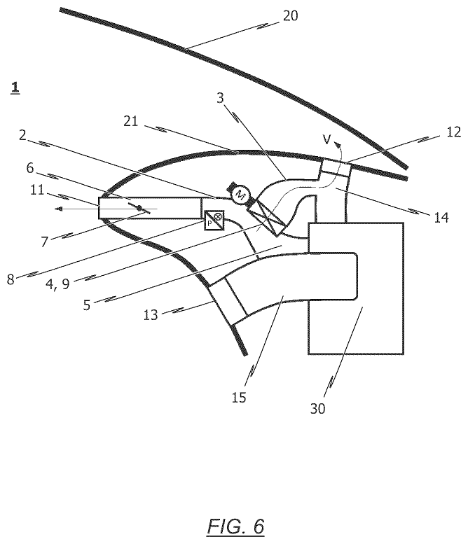

The design variant of the air vent system 1 according to the disclosure shown in FIG. 6 substantially corresponds to the variant shown in FIG. 4; however, in the embodiment shown in FIG. 6, the airflow controller 4 is not designed to be passive in the form of a check assembly 10, but rather to be active.

For this purpose, a pressure sensor 8 is disposed in the downstream second region 6 of the main channel 2 in order to measure the static pressure therein. If a critical pressure level is exceeded, a valve 9 is opened at least in regions with the help of the airflow controller 4, such that the bypass channel of the bypass system 3 is connected to the main channel 2 via a fluidic connection. The valve 9 is preferably embodied as an electric valve 9, in particular as a valve slide.

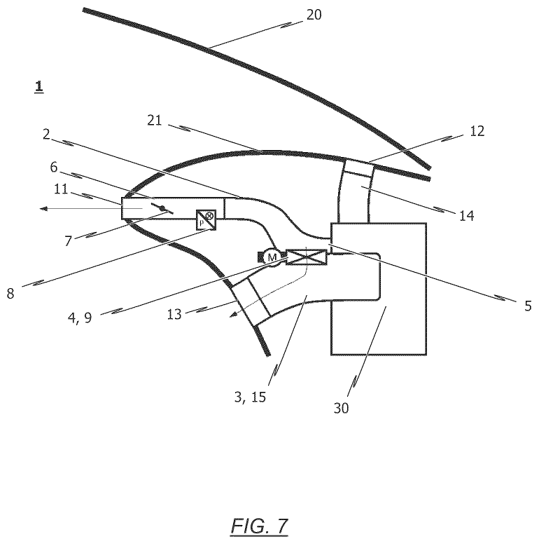

The design variant of the air vent system 1 according to the disclosure shown in FIG. 7 substantially corresponds to the fifth embodiment, as shown in FIG. 5, wherein, however, the airflow controller 4 here as well is also not embodied as a passive system with a check assembly 10, but rather—as with the sixth design variant according to FIG. 6—with a corresponding pressure sensor 8, which is arranged in the downstream second region of the main channel 2, and with a valve 9 which is controllable with an electric motor, via which the air channel 15 that leads from the climate control unit 30 to the third air vent 13, i.e., to the footwell nozzle, is connected or can be connected via a fluidic connection to the main channel 2.

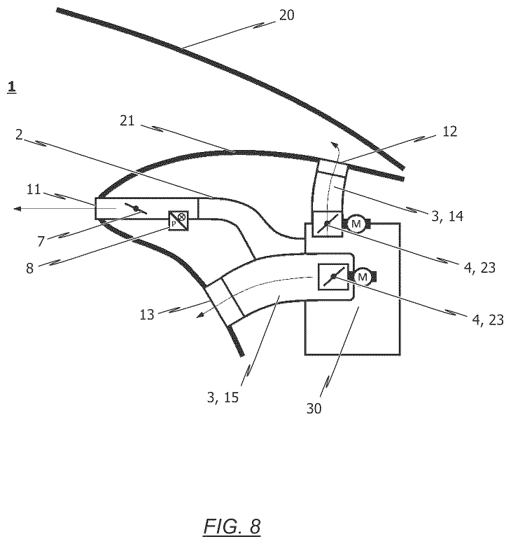

Finally, an alternative design variant is shown in FIG. 8. Here as well, an active airflow controller 4 is used with a pressure sensor 8 disposed in the main channel 2 of the air vent system 1.

However, in the design variant shown in FIG. 8, the bypass system 3 is already integrated in the air channels 14, 15 that lead from the climate control unit 30 to the second air vent 12 (to the defroster nozzle) and to the third air vent 13 (to the footwell nozzle). These air channels 14, 15 are provided with corresponding dosing elements 23, in particular dosing flaps, which are driven by an electric motor when the pressure sensor 8 senses that the static pressure in the main channel 2 exceeds a predetermined or fixed value.

The design variants of the air vent system 1 shown in the drawings are briefly summarized below.

Generally, a plurality of air vent openings for supplying heated or cooled air are generally present in an assembly in order to control the climate in a vehicle interior. These include air vents 11 that are oriented towards the vehicle occupants, air vents 13 that serve to ventilate the footwell, or also air vents 12 that serve to defrost the windshields.

The air vent openings are located in the instrument panel 21 and are connected to a climate control unit 30 with air guides and air channels 2, 14, 15. According to the settings of the climate control unit 30, the temperature-controlled air is now directed into the various air guides 2, 14, 15. For this purpose, motorized flaps (for example, dosing elements 23—FIG. 8) are used that open or close the entrances to the air guides 2, 14, 15.

By combining different flap positions, different climate control scenarios can be set to thus achieve a targeted heating of the footwell, a targeted defrosting of the windshield 20, or a targeted directing of the air towards the vehicle occupants.

If, for example, the air is directed towards the vehicle occupants by the air vent 11, a high pressure drop is created particularly in the case of high flow rates and air vents with small cross-sections that are suitable for being positioned discretely in the instrument panel 21. This is composed of the dynamic pressure of the flow and the overall pressure level as compared to the environment due to the flow resistance present in the air vent 11.

The flow resistance may increase significantly depending on the position of the air-conducting elements in the air vent 11 (not shown here). The pressure drop into the air vent 11 and air channels 2, 14, 15 taken together has an impact on the amount of air that the fan is able to transport into the vehicle interior against this pressure drop.

Further variables that limit this flow rate are the fan output and the fan characteristic curve. Typically, high power fans are required for systems with high pressure loss, however, these are either not available for vehicles or not desired due to the required high energy demand.

The desire for discrete air outlets hidden in the instrument panel 21, e.g., in joints or design edges, is opposed to this, since air vents with a small flow region are desirable due to the available installation space. These in turn cause a high pressure drop due to their small cross section and the therefore high required flow rate.

However, a high pressure drop in the air vent not only requires a high fan output, it is also an indicator of the sound emissions of the air vent, along with the high flow rate in the air vent caused by the small cross section of the air vent.

Loud flow noises from the air vents are not, however, desirable in modern vehicles, especially in the case of electric vehicles.

However, a certain flow rate is required for rapid air conditioning of a vehicle, for example for rapidly cooling a vehicle that has been in the sun. This creates a conflict of goals between vehicle design and climate control.

This conflict of goals can be resolved by controlling the air in the system in a pressure-dependent manner. To this end, a valve 9 is actively or passively opened when a certain pressure is reached and allows the flow rate to flow via a bypass 3 into one or more other air channels 14, 15 via further air vent openings 12, 13.

This achieves the result that, especially at higher fan settings, a significant and clearly noticeable air flow exits the air vent 11, and the volume flow necessary for climate control additionally reaches the vehicle interior via further ventilation openings of further air vents 12, 13. This ensures that the air vents 11 which are directed towards the occupants also generate a veritable air flow there and at the same time, that the temperature in the vehicle interior is quickly controlled. The fan output required for climate control may remain limited with such an arrangement.

If the shut-off and dosing flap 7 is closed in the air vent 11 or the closing lamellar system is brought into the closed position to prevent air leakage via the air vent 11, the fan operates against the closed flap 7, especially at higher fan settings. In the worst case, the pressure present in the air outlet 11 causes noise or whistling as the air passes through remaining narrow gaps in the air vent 11.

If there is only one air vent 11 open in the instrument panel 21, the entire air flow exits through it. This can result in both annoying noises and an unpleasant air flow. In this case, the valve 9 opened at a particular pressure may limit noises and the flow rate.

In any case, with air vents 11 closed, the fan is working against increased resistance. This results in energy being consumed without any effect for the ventilation of the vehicle interior. Further, it also takes much longer for a desired climate control result to be achieved, and so more energy is consumed than would ideally be required for the climate control, which has a negative impact on range, especially for electric vehicles. This case has been and is still often observed and the introduction of automatic climate control is in response to this.

In consideration of the way automatic climate control systems work, especially when commencing travel, it is noticeable that, as the operating temperature of the engine is reached, the fan output is increased to a maximum in order to achieve a rapid heating of the vehicle interior. Even with the rapid cooling of the interior, a high fan output is initially set. After reaching the desired interior temperature, the fan output is reduced to a minimum once again. In addition, it can be observed that the heat loss in the vehicle interior is reduced by supplying as little fresh air as possible from the outside in order to prevent too much heated air from being blown out via the pressure outlet valves of the body. To achieve this, the recirculation control of the climate control device is switched accordingly.

The recirculated air is distributed across both the air vents as well as the defroster nozzle and footwell ventilation system ideally for the well-being of the vehicle occupants.

As already explained above, limiting the pressure drop in the air vent system 1 is required, especially at higher fan output levels. In the case of climate control using an automatic climate control system, this would be the case, above all in the early phase of travel, in which a rapid temperature control of the vehicle interior is to be achieved. After this phase, the fan output is reduced because it is no longer needed. Now the constant maintenance of the temperature with low fan output and connected recirculation operation begins. In this phase, typically no pressure drops are achieved in the air vent system 1 that are so high that they would require activation of a valve and the system may operate in the same manner as in previous arrangements.

An arrangement with a pressure-controlled valve 9 can also be realized with a pressure sensor 8, which can be arranged as a pressure transducer in an air vent or upstream of the air vent. This can provide a signal via a control unit to a motorized valve 9, which then allows the positive pressure to be diverted to another air vent.

FIG. 1 shows a ventilation system of a vehicle in a schematic view with an air vent 11, air guides, a climate control unit 30, and air vent openings 13, 14. In the illustrated arrangement, the air vent is connected to the air guide via a bypass and directs the air blown off through the valve 9 to the defroster nozzle 12 at a certain pressure.

FIG. 2 shows a schematic view of a ventilation system of a vehicle having an air vent, air guides, a climate control unit, and air vent openings. In the illustrated arrangement, the air vent is connected to the air guide via a bypass and directs the air blown by the valve 9 to the ventilation nozzle 13 in the footwell at a certain pressure.

FIG. 3 shows a schematic view of a ventilation system of a vehicle having an air vent, air guides, a climate control unit, and air vent openings. In the illustrated arrangement, the air vent has a valve 9 and directs the air blown by the valve 9 under the instrument panel at a certain pressure, where it is distributed.

FIG. 4 shows a schematic view of a ventilation system of a vehicle having an air vent, air guides, a climate control unit, and air vent openings. In the illustrated arrangement, the air guide is connected to the air guide via a bypass. The valve 9 connects the air channel to the bypass. The bypass is used to direct the air blown off at a certain pressure into the air channel and guide it to the defroster nozzle.

FIG. 5 shows a schematic view of a ventilation system of a vehicle having an air vent, air guides, a climate control unit, and air vent openings. In the illustrated arrangement, the air guide is connected to the air guide via a valve 9. Via the valve 9, the air blown off at a certain pressure is directed into the air guide and guided to the footwell nozzle.

FIG. 6 shows a schematic view of a ventilation system of a vehicle having an air vent, air guides, a climate control unit, and air vent openings. In the illustrated arrangement, the air guide is connected to the air guide via a bypass, whereby the bypass is connected to the air guide via a motor-controlled valve 9. The bypass is used to guide the air blown off at a certain pressure through the motor-controlled valve 9 to the defroster nozzle. The signal for opening the motor-controlled valve is triggered via the pressure sensor 8.

FIG. 7 shows a schematic view of a ventilation system of a vehicle having an air vent, air guides, a climate control unit, and air vent openings. In the illustrated arrangement, the air guide is connected to the air guide via a motor-controlled valve 9. Via the motor-controlled valve 9, the air blown off at a certain pressure is directed into the air guide and guided to the footwell nozzle. The signal for opening the motor-controlled valve is triggered via the pressure sensor 8.

FIG. 8 shows a schematic view of a ventilation system of a vehicle having an air vent, air guides, a climate control unit, and air vent openings. A pressure sensor 8 is arranged in the air vent and transmits a signal to the climate control unit (not shown). When a certain pressure level is reached, a flap is opened in the air conditioning device, for example to the air channel, so that the pressure in the air vent can escape via the air channel, the motorized flap in the air channel, and finally via the air nozzle in the footwell. Alternatively or additionally, a second motor-controlled valve may permit a flow into a further air channel and then allow the air to escape, for example via the defroster nozzle.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Air vent system
2 Main channel
3 Bypass system/bypass channel
4 Airflow controller
5 Upstream first region of the main channel
6 Downstream second region of the main channel
7 Airflow regulating element
8 Pressure sensor 9 Motor controllable valve unit

Check assembly
11 First air vent
12 Second air vent/defroster nozzle
13 Third air vent/footwell nozzle
14 Air channel for the second air vent
15 Air channel for the third air vent
20 Windshield
21 Dashboard/instrument panel
23 Dosing element/dosing flap
30 Climate control unit

What is claimed is:

1. An air vent system (1) for a motor vehicle, wherein the air vent system (1) comprises the following:
at least one main channel (2) for conducting a first portion of a total airflow flowing through the air vent system (1);
at least one bypass system (3) for conducting a second portion of the total airflow through the air vent system (1); and
an airflow controller (4) configured so as to subdivide the total airflow flowing through the air vent system (1) in such that
(i) a portion of the total airflow flowing through the air vent system (1) is only conducted through the at least one bypass system (3) when a volumetric flow rate of the air flowing through the at least one main channel (2) reaches or exceeds a first predefined or definable value; and/or
(ii) a volumetric flow rate of the air flowing through the at least one main channel (2) does not exceed a second predefined or definable value.

2. The air vent system (1) according to claim 1, wherein the at least one main channel (2) is subdivided into an upstream first region (5) and a downstream second region (6), wherein the bypass system (3) is or can be fluidly connected to a region of the at least one main channel (2) between the upstream first region (5) and the downstream second region (6) of the at least one main channel (2) via the airflow controller (4).

3. The air vent system (1) according to claim 2, wherein, in the downstream second region (6) of the at least one main channel (2), at least one adjustable, airflow-regulating element (7) in the form of a flap or a closing slat system is arranged.

4. The air vent system (1) according to claim 2, wherein the airflow controller (4) comprises at least one pressure sensor (8) configured so as to sense a pressure.

5. The air vent system (1) according to claim 2, wherein the airflow controller (4) comprises at least one motor-controllable valve unit (9), via which the bypass system (3) is or can be fluidly connected to a region of the at least one main channel (2) between the upstream first region (5) and the downstream second region (6) of the at least one main channel (2).

6. The air vent system (1) according to claim 1, wherein the airflow controller (4) comprises a check valve (10), which is arranged or configured such that, upon exceeding a predefined or definable pressure, in particular a static pressure, in at least one main channel (2), the check valve (10) opens and conducts a portion of the total airflow flowing through the air vent system (1) through the at least one bypass system (3).

7. The air vent system (1) according to claim 1, wherein the at least one main channel (2) is configured as a first air channel for supplying air to at least a first air vent (11).

8. The air vent system (1) according to claim 7, wherein the at least one bypass system (3) comprises at least one bypass channel, which is fluidly connected to a second air channel (14, 15) for supplying air to a second air vent (12, 13).

9. The air vent system (1) according to claim 8, wherein the second air vent (12, 13) is configured as at least one defroster nozzle (12) or as at least one footwell nozzle (13).

10. The air vent system (1) according to claim 7, wherein the at least one first air vent (11) is configured as at least one air vent arranged or to be arranged in an instrument panel (21) of the motor vehicle.

11. The air vent system (1) according to claim 1, wherein the air vent system (1) further comprises a climate control unit (30), which is configured so as to supply an airflow to the at least one main channel (2) and/or an airflow to at least one further air channel (14, 15).

12. The air vent system (1) according to claim 11, wherein the climate control unit (30) is configured so as to adjust a volumetric flow rate of the air channel supplied to the at least one further air channel (14, 15) in the at least one main channel (2) as a function of a pressure.

13. The air vent system (1) according to claim 4, wherein the pressure is a static pressure in the downstream second region (6) of the at least one main channel (2).
